(19) United States
(12) Patent Application Publication
(10) Pub. No.: US 2019/0343077 A1
(43) Pub. Date: Nov. 14, 2019

(54) CAT TOY

(71) Applicant: Cabo Holdings, LLC, Tulsa, OK (US)

(72) Inventor: Michael Brian Boshears, Broken Arrow, OK (US)

(73) Assignee: Cabo Holdings, LLC, Tulsa, OK (US)

(21) Appl. No.: 16/412,378

(22) Filed: May 14, 2019

Related U.S. Application Data
(60) Provisional application No. 62/671,048, filed on May 14, 2018.

(51) Int. Cl. A01K 15/02

(52) U.S. Cl. CPC A01K 15/025

(57) ABSTRACT

The invention relates to an improved cat toy. The cat toy includes a main body having one or more annular openings allowing access to a toy mounted within the main body. The cat toy also includes a non-slip base member attached to a terminal end of a lower portion of the main body. The lower portion of the main body may be circular or annular, and covered or wrapped with a scratch pad-type material, such as carpet. Additionally, a lid is pivotally or rotatably attached within a lid opening of the main body, and the toy is attached to the lid.

### CROSS REFERENCE TO RELATED APPLICATIONS

The application claims the benefit of and priority to U.S. Provisional Patent Application No. 62/671,048 filed May 14, 2018, and incorporates by reference said provisional application in its entirety.

### BACKGROUND OF THE INVENTION

### 1. Field of the Invention

This Invention Relates Generally to an Improved Cat Toy.

### 2. DESCRIPTION OF THE RELATED ART

A wide variety of pet toys are known, which range from simple, inexpensive structures of limited, useful life to complex, expensive structures of great usefulness and durability. Nevertheless, there is a lack of good suitable toys for pet cats. Cats are generally more restrictive in play and while of generally high intelligence, cannot be confined in their behavior for repetitive manipulation of toys. Cats, more easily than most animals, tire of specific playthings once they have mastered them and act disdainfully of those that are too simple.

It is therefore desirable to provide an improved cat toy that is simple in structure, yet durable and inexpensive and above all, continually challenging to the pet cat.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### BRIEF SUMMARY OF THE INVENTION

In general, in a first aspect, the invention relates to an improved cat toy. The cat toy includes a hollow main body having a toy mounted therein. The main body has one or more annular openings allowing access the toy mounted within the main body. The cat toy also includes a base member attached to a terminal end of a lower portion of the main body. The base member may be constructed of rubber or other suitable material to prevent/minimize slippage of the cat toy during usage. The lower portion of the main body may be circular or annular and covered or wrapped with a scratch pad-type material, such as carpet. Additionally, a lid is pivotally or rotatably attached within a lid opening of the main body, and the toy is attached to the lid.

The annual openings may be two (2) coaxial aligned and axial spaced annular openings with the toy accessible through either of the openings. Further, the lid can be pivotally or rotatably attached to the main body using trunnion support members enabling the lid to pivot or rotate 360 degrees within the lid opening. The toy, such as a mouse or other animal, a ball, or any other appropriate cat toy, may be attached to the lid using a compression spring. The toy can be configured to squeak, shake and/or make other movements and/or audible noises. These movements of the toy cause the lid to pivot or rotate within the lid opening of the main body. In addition, the toy constructed and configured to pop-out of the annular openings within the main body.

The cat toy may further include one or magnets attached to the lid at suitable points to initiate movement of the lid based on a positive and a negative charged end of the magnets. Additionally, one or more lights and/or lasers may be attached to the lid and electrically connected to a power source. Further, the lid may be motion-activated. Moreover, the cat toy may include a toroidal track integrated into or constructed about the lower portion of the main body. The track can have a ball or an electronic mouse or animal.

In general, in another aspect, the invention relates to a cat toy having a main body comprising a semi-spherical upper portion and an annular lower portion. The upper portion of the main body has coaxial aligned and axial spaced annular openings. Additionally, the upper portion of the main body has a lid opening with a pair of trunnion support members protruding therein. A lid is positioned within the lid opening of the main body, and the lid is connected to the trunnion support members of the main body. A cat toy is attached to the lid and is accessible through either of the openings in the main body. A base member is attached to a terminal end of the lower portion of the main body. The base member is a non-slip material, such as rubber. Further, the lower portion of the main body may be covered or wrapped with a scratch pad-type material.

The foregoing has outlined in broad terms some of the more important features of the invention disclosed herein so that the detailed description that follows may be more clearly understood, and so that the contribution of the named inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a perspective view of an example of a cat toy with the lid rotatable 360 degrees in accordance with an illustrative embodiment of the invention disclosed herein;

FIG. 2 is a side elevation view of the cat toy shown in FIG. 1;

FIG. 3 is a side elevation view of the cat toy shown in FIG. 1, opposite the side elevation view shown in FIG. 2;

FIG. 4 is a front elevation view of the cat toy shown in FIG. 1;

FIG. 5 is a rear elevation view of the cat toy shown in FIG. 1, opposite the front elevation view shown in FIG. 4;

FIG. 6 is a top elevation view of the cat toy shown in FIG. 1;

FIG. 7 is a bottom elevation view of the cat toy shown in FIG. 1;

FIG. 8 is a perspective exploded view of the cat toy shown in FIG. 1.

FIG. 9 is a cross-sectional side elevation view of the cat toy shown in FIG. 2;

FIG. 10 is a side elevation view of the cat toy shown in FIG. 1 with the lid shown in rotatable orientations in accordance with an illustrative embodiment of the invention disclosed herein;

FIG. 11 is a perspective view of an example of a powered cat toy in accordance with an illustrative embodiment of the invention disclosed herein;

FIG. 12 is a side elevation view of the cat toy shown in FIG. 11;

FIG. 13 is a side elevation view of the cat toy shown in FIG. 11, opposite the side elevation view shown in FIG. 12;

FIG. 14 is a front elevation view of the cat toy shown in FIG. 11, with the opposite rear elevation view being a mirror image thereof;

FIG. 15 is a top elevation view of the cat toy shown in FIG. 11;

FIG. 16 is a bottom elevation view of the cat toy shown in FIG. 11;

FIG. 17 is a perspective exploded view of the cat toy shown in FIG. 11;

FIG. 18 is a cross section view of the cat toy shown in FIG. 12;

FIG. 19 is a perspective view of an example of a powered cat toy with internal components removed from a lid in accordance with an illustrative embodiment of the invention disclosed herein; and

FIG. 20 in a perspective view of an example of a motor disk in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the invention. It should be understood, however, that the disclosure is to be considered an exemplification of the principles of the invention and is not intended to limit the invention to the specific embodiments so described.

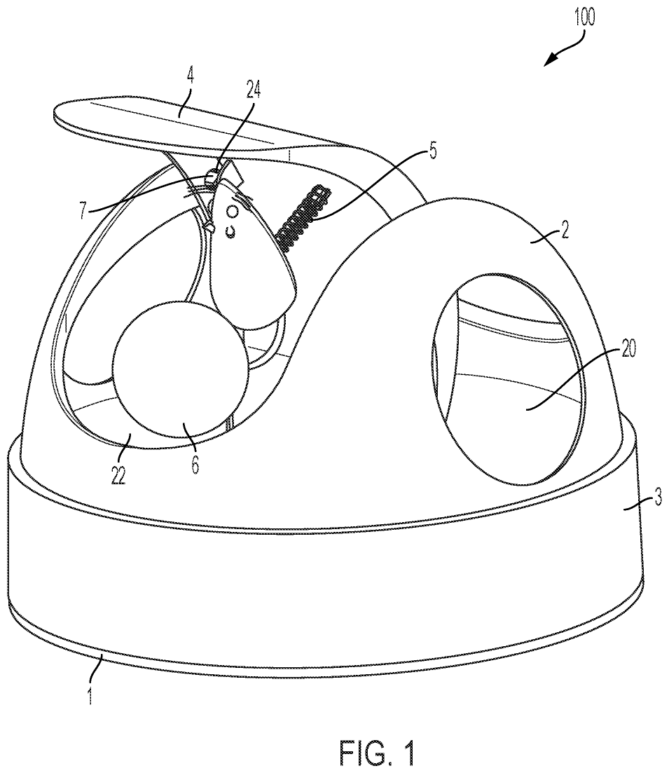

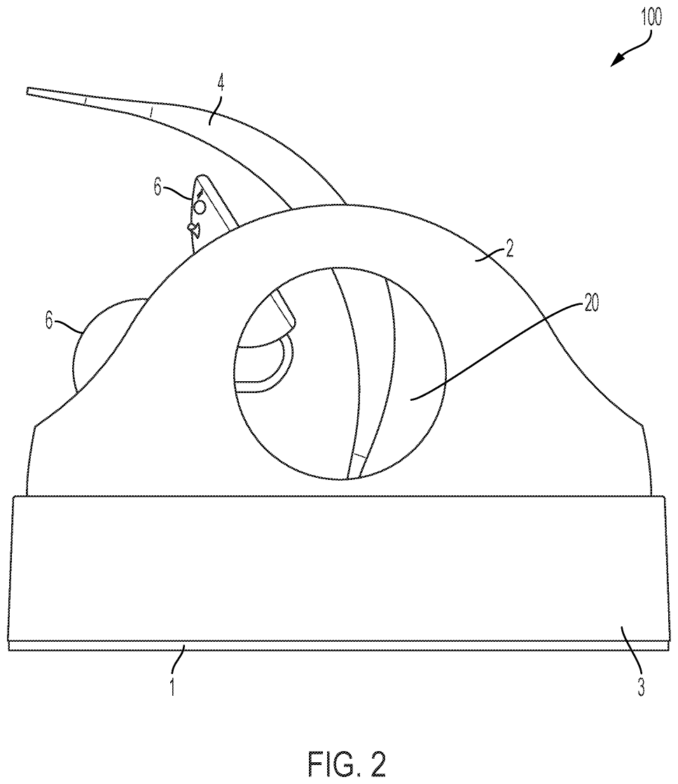

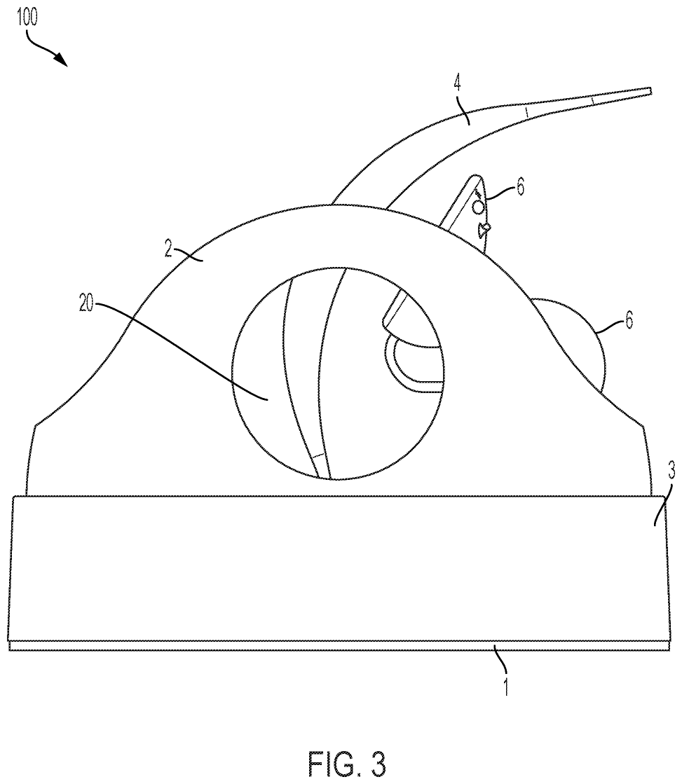

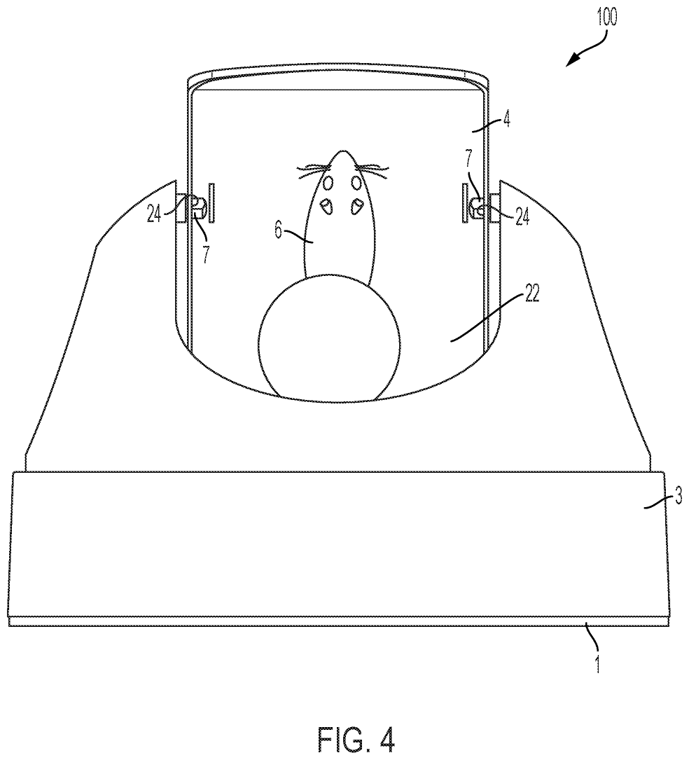

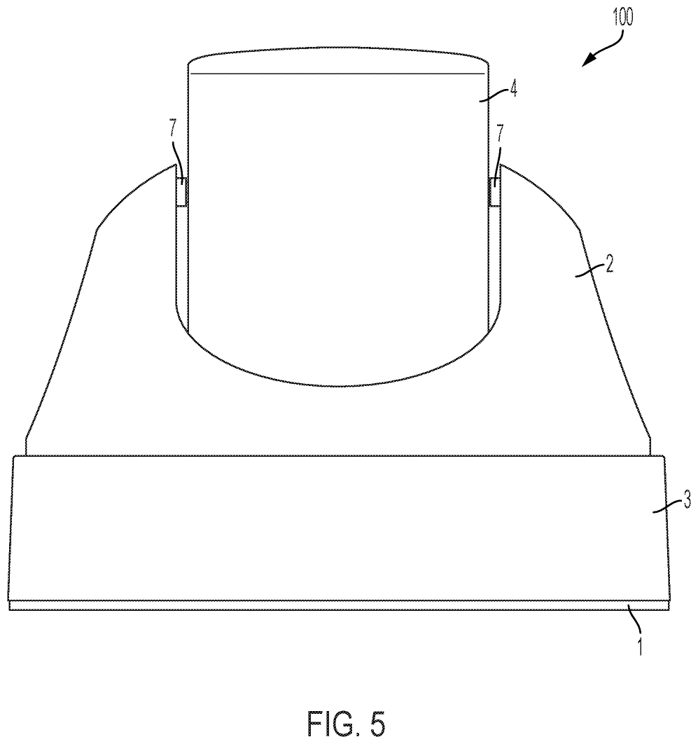

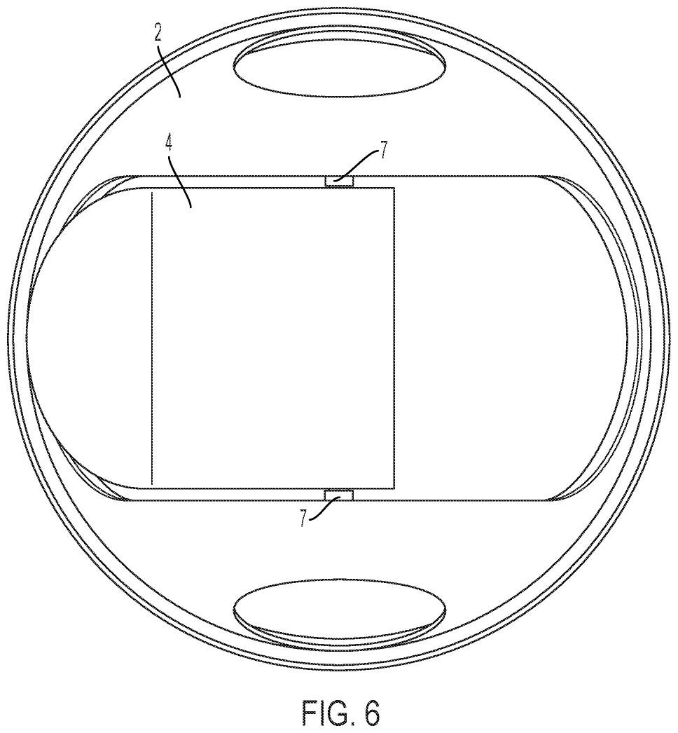

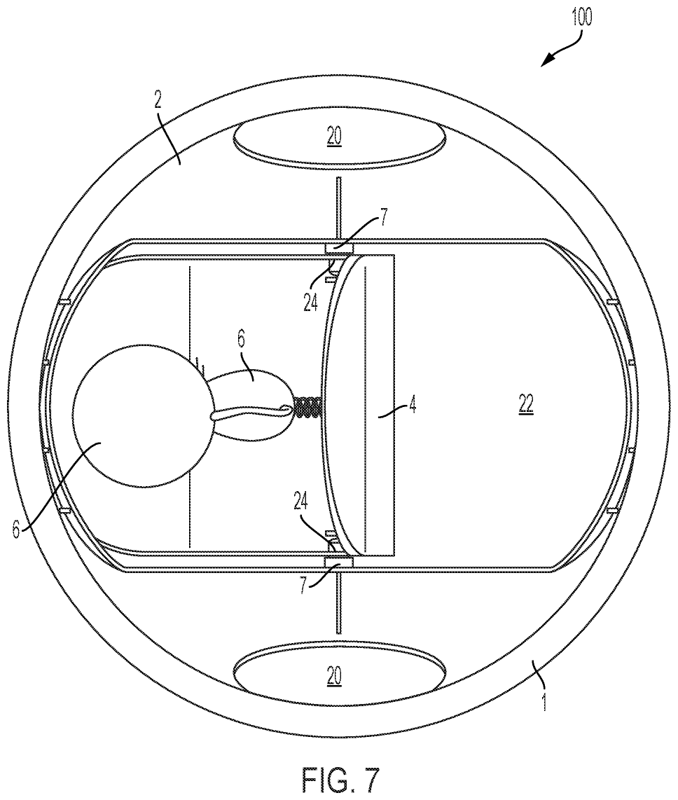

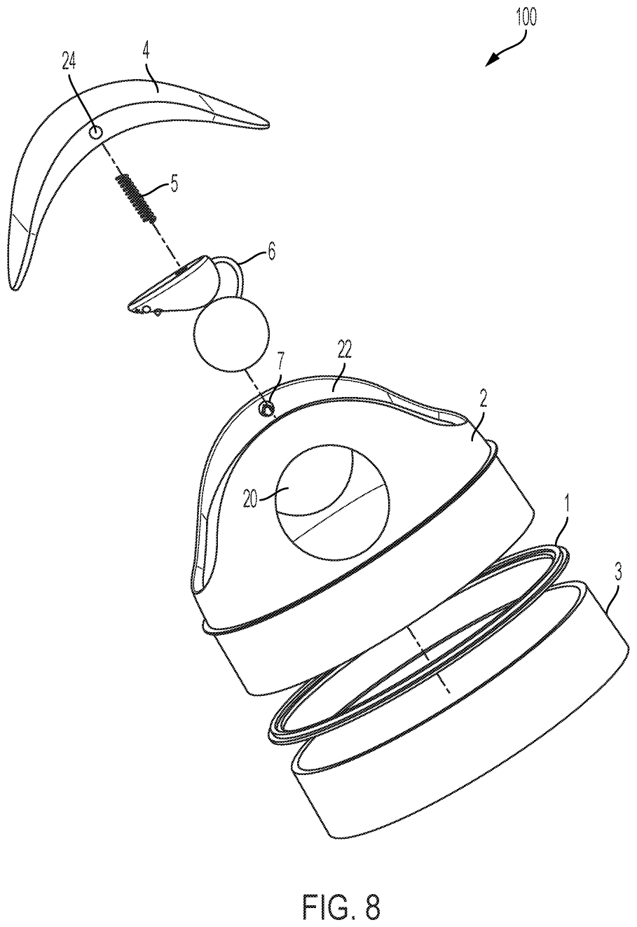

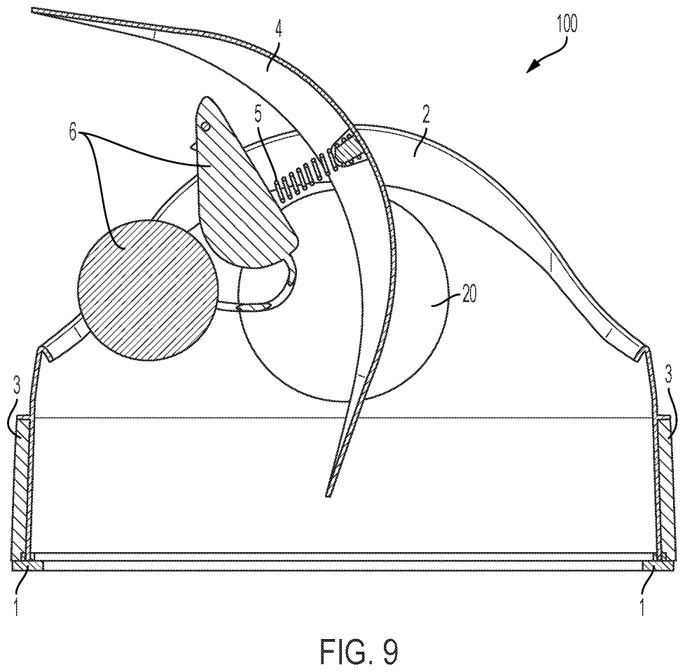

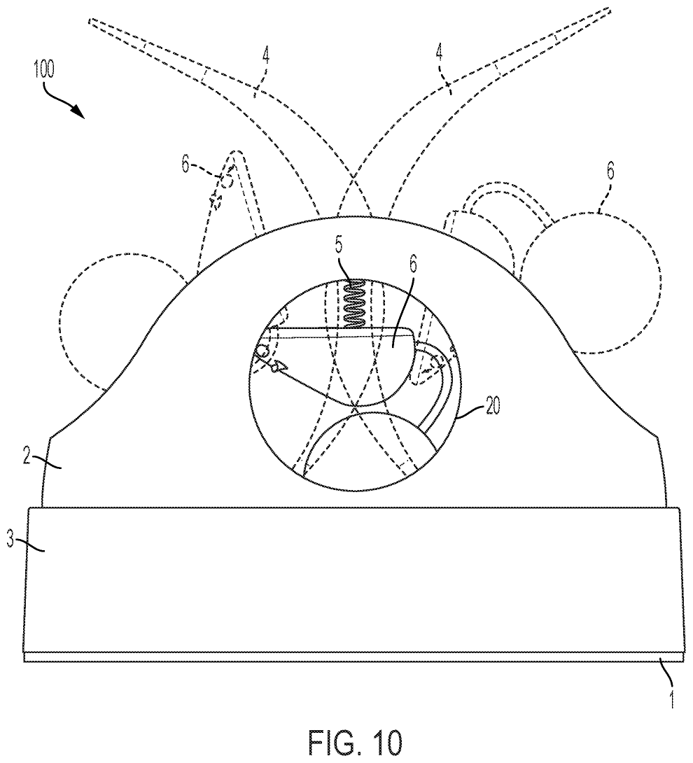

Referring now to the figures of the drawings, wherein like numerals of reference designate like elements throughout the several views, FIGS. 1 through 10 illustrate a cat toy 100 having a hollow main body 2 containing a toy 6 mounted therein. The cat toy 100 can include a base member 1 attached to a terminal end of a lower portion of the main body 2. The base member 1 is constructed of rubber or other suitable material to prevent/minimize slippage of the cat toy during usage. As illustrated, an upper portion of the main body 2 is semi-spherical and the lower portion of the main body 2 is circular or annular, but the invention is not so limited; the upper portion and/or the lower portion of the main body 2 can take any geometric form. In addition, a portion of the main body 2 may covered or wrapped with a scratch pad-type material 3, such as carpet. The scratch pad material 3 may be secured to the main body 2 with the base member 1 or can be otherwise removably attachable to the main body 2. Moreover, the main body 2 may include one or more annular side openings 20 allowing the pet to access the toy 6 mounted within the main body 2. As illustrated, the main body 2 includes two (2) coaxial aligned and axial spaced annular side openings 20 with the toy 6 accessible to the pet cat through either opening 20.

The cat toy 100 also includes a lid 4 pivotally or rotatably attached to the upper portion of the main body 2. The lid 4 is positioned within a lid opening 22 in the main body 2, and may be attached to the main body 2 using trunnion support members 7 enabling the lid 4 to pivot or rotate 360 degrees within the lid opening 22. The trunnion support members 7 are axially spaced, coaxially aligned, and separated by the lid opening 22 to rotatably support the lid 4 by protruding into axially spaced and coaxially aligned lid openings 24 in the lid 4. An upper or outer surface of the lid 4 may be arcuate in shape in order to have a mating configuration with the semi-spherical upper portion of the main body 2. The toy 6 is mounted to the lid 4, such as using a compression spring 5. The toy 6 may be in the form of a mouse or other animal, a ball, or any other appropriate toy or combination of toys. In addition, the toy 6 can squeak, shake and/or make other movements and/or audible noises when the cat bats and plays with the toy 6. The compression spring 5 or other mounting means may be configured such that the toy 6 mounted may be exchanged for another appropriate toy. The movement of the toy 6 can also be configured to cause the lid 4 to pivot or rotate about the trunnion support members 7 of the main body 2.

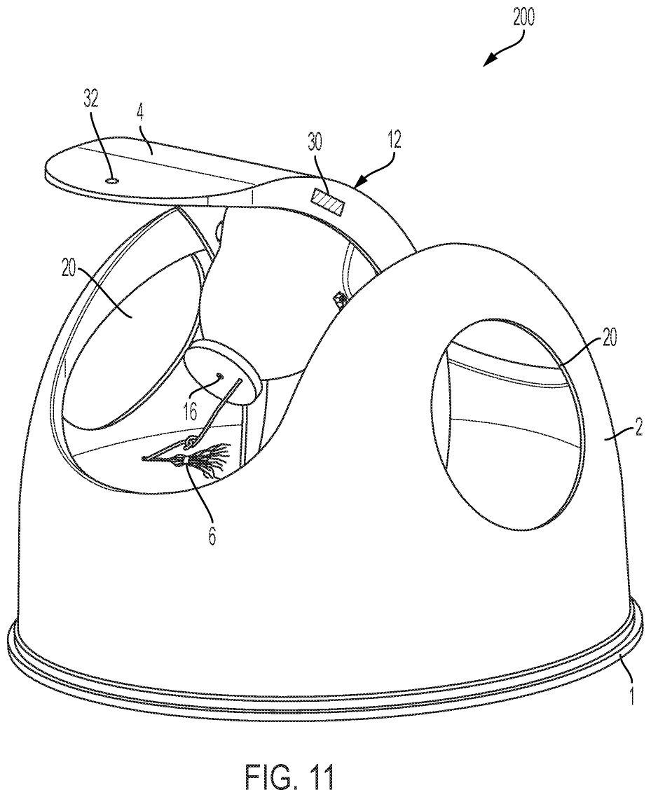

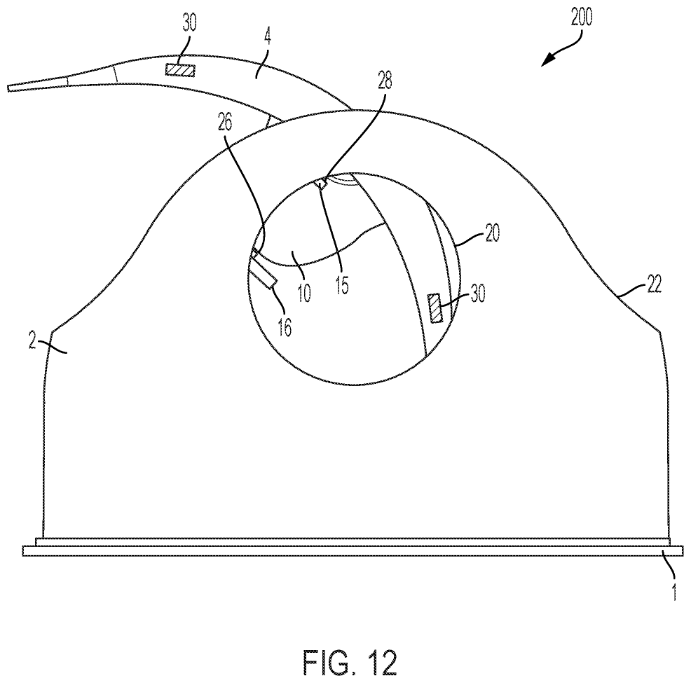

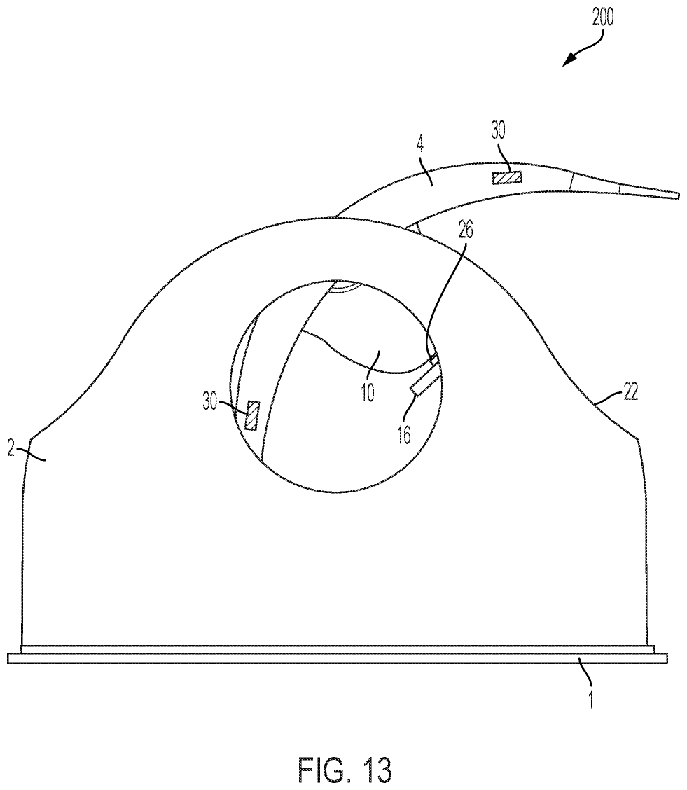

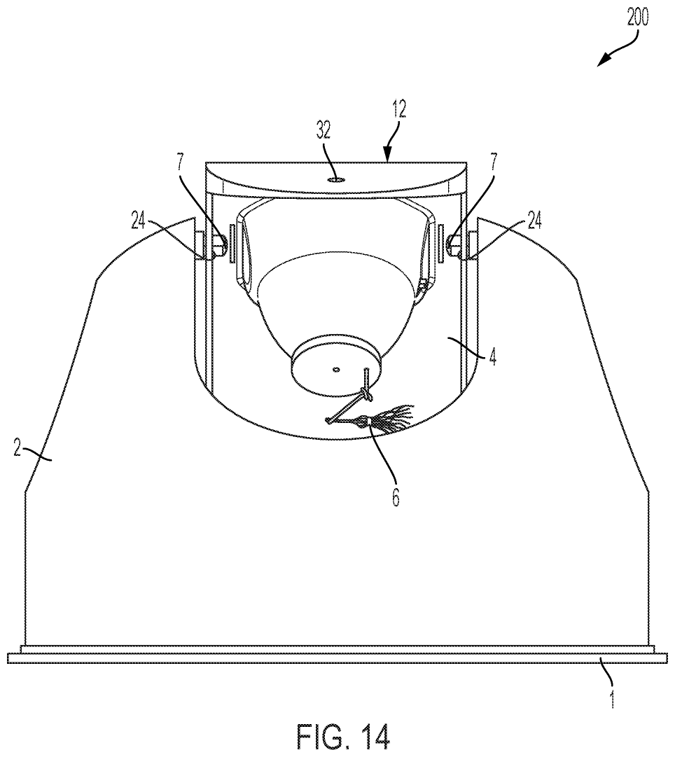

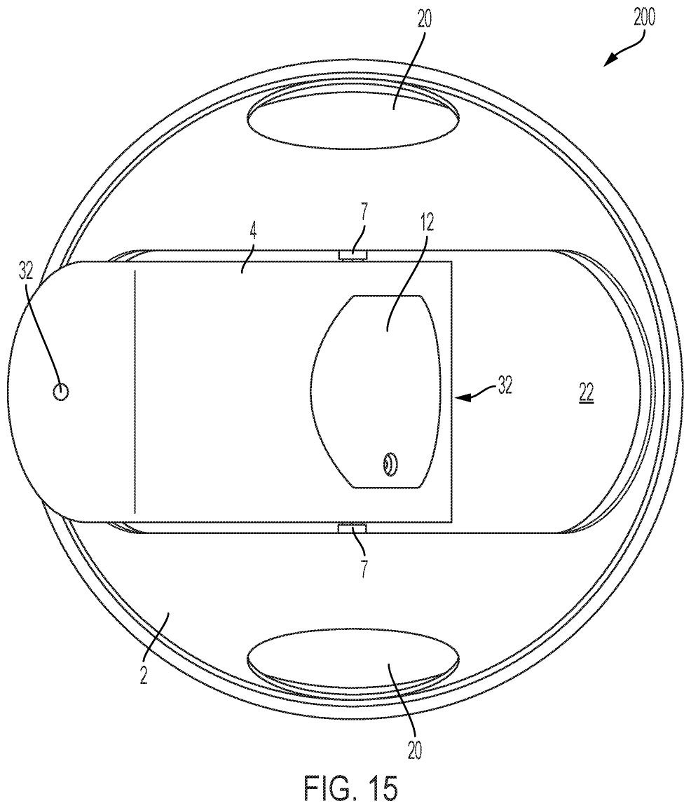

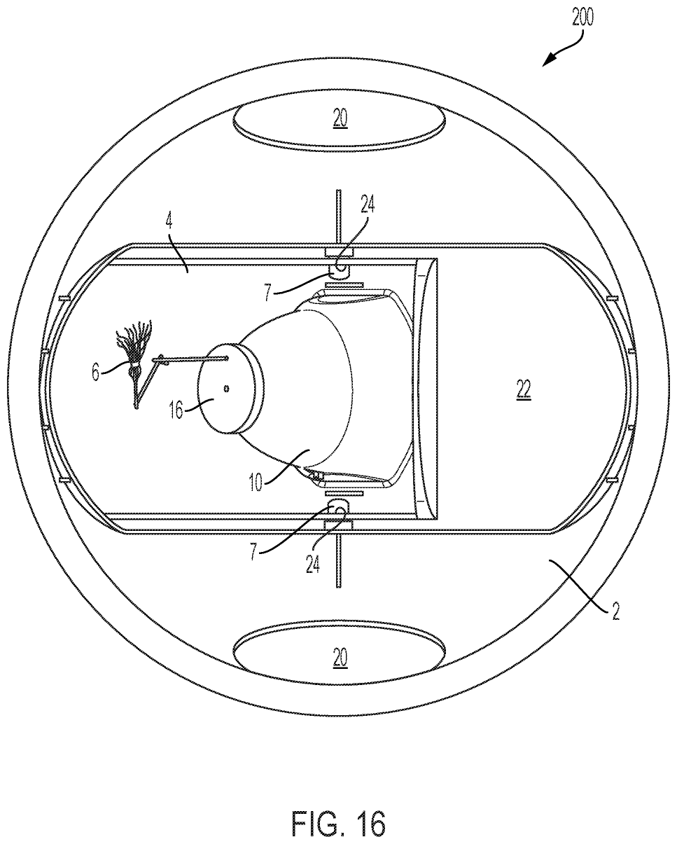

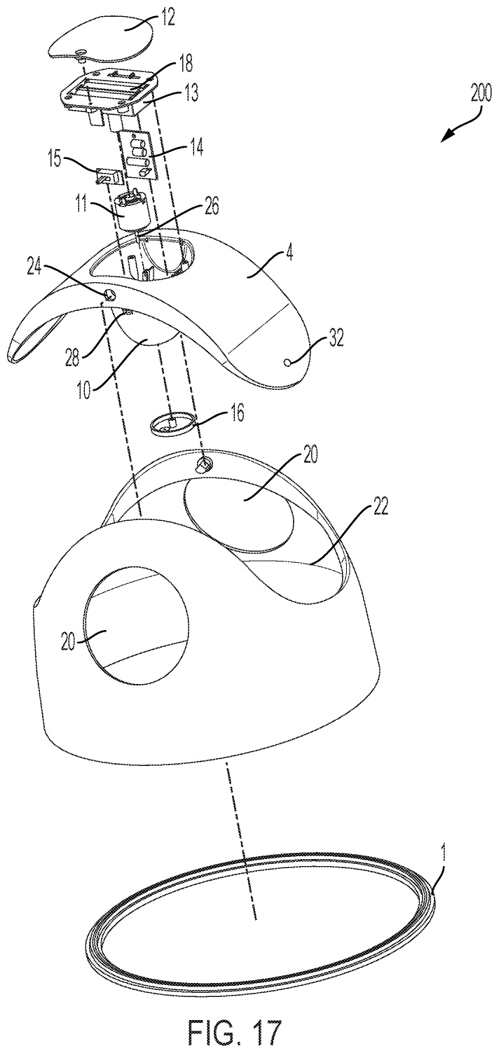

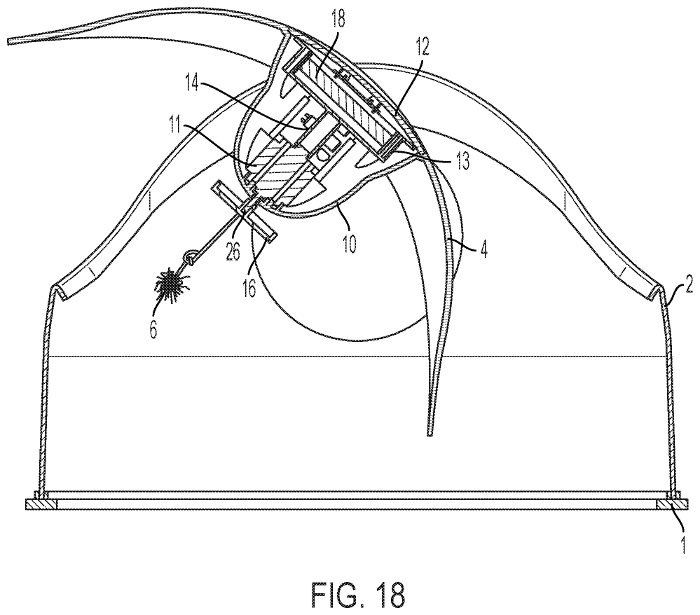

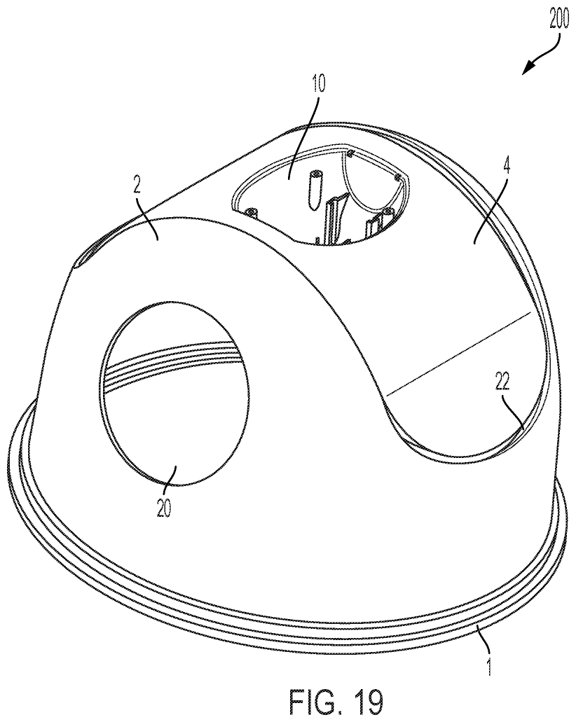

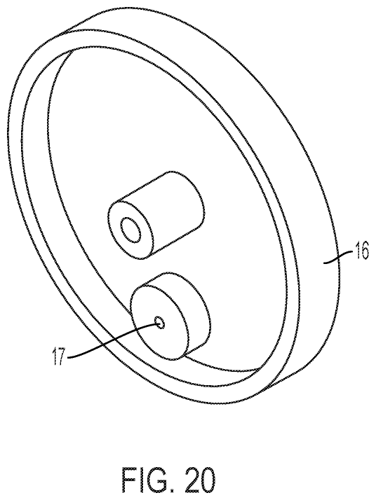

Turning now to FIGS. 11 through 20, an electronic cat toy 200 has a hollow main body 2 and a lid 4 pivotally or rotatably attached within a lid opening 22 of the main body 2. The cat toy 200 can also include a scratch pad material 3 covering a lower portion of the main body 2 and/or a base member 1 attached to a terminal end of a lower portion of the main body 2. Similar to the cat toy 100 exemplified in FIGS. 1 through 10, the lid 4 is positioned within the lid opening 22 in the main body 2, and is attached to the main body 2 using trunnion support members 7 enabling the lid 4 to pivot or rotate 360 degrees within the lid opening 22.

The lid 4 of the electronic cat toy 200 also includes a motor housing 10 and battery cover 12. The motor housing 10 is secured to or integrally fabricated with a bottom side of the lid 4, occupying a portion of the annular space within the main body 2 while still allowing the lid 4 to pivot or rotate 360 degrees within the lid opening 22. The battery cover 12 is positioned on an upper side of the lid 4 and is removably mounted to the motor housing 10 using screws or other suitable fasteners. The battery cover 12 and the motor housing 10 together define an annular space which contains a motor 11, a battery housing 13, a controller board 14 and an on/off switch 15. A drive shaft 26 of the motor 11 extends through an opening in the motor housing 10 and is attached to a rotatable toy mount disk 16. A toy 6 is attached to the mount disk 16 such that the powered rotation of the drive shaft 26 causes the toy 6 to move within the annular space within the main body 2. The toy 6 may comprise a mouse or other animal, a ball, or any other appropriate toy or combination of toys. The manner in which the toy 6 is attached to the mount disk 16 may allow for the toy 6 to be removed and exchanged for another appropriate toy. The toy 6 may be accessible by a pet cat through two (2) coaxial aligned and axial spaced annular openings 22 in the main body 2.

The battery housing 13 may hold batteries 18 which power the controller board 14 and motor 11. The powered motor 11 moves the mount disk 16 which in turn moves the toy 6 attached thereto. In addition, the motor 11 may also cause the lid 4 to rotate within the main body 2. The motor 11 may be powered off and on by the switch 15. The switch 15 is accessible through an opening 28 in the motor housing 10; alternatively, the switch 15 may be accessible through an opening in the lid 4 or may be contained within the annular space between the motor housing 10 and battery cap 12. The movements of the motor 11 may be initiated by the controller board 14 randomly, by a motion sensor, or by any other sufficient means of activation. The motor 11 and the lid 4 may be configured such that the motor 11 may initiate the rotary movement of the lid 4.

The cat toy 100/200 disclosed herein can be passively powered by the movement and play of the pet cat. The cat toy 100/200 may also include one or magnets 30 attached to the lid 4 at suitable points to initiate movement of the lid 4 based on the positive and negative charged ends of the magnets (e.g., push and pull of the lid 4 during usage). In addition, the cat toy 100/200 can include a one or more lights and/or lasers 32 attached to the lid 4 and electrically connected to the batteries 18. The lights can be light emitting diode (LED) lights that may be mounted on either side of the lid 4 so that when the lid 4 moves the LED lights would shine based on the movement of the lid 4. Similarly, the lid 4 can be motion-activated by the pet cat that would initiate the lid 4 into movement.

The cat toy 100/200 may also include a ball and track integrated into or constructed about the lower portion of the main body 2. Likewise, an electronic mouse or animal could be constructed with the track about the lower portion of the main body 2. The electronic mouse or animal may be battery powered or electrically connected to the power source (e.g., batteries 18 or a secondary/external power source), and would move within the track around the lower portion of the main body 2. Further, the main body 2 could include a mouse or other animal constructed and configured to pop-out of the annular openings within the main body 2.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

Still further, additional aspects of the invention may be found in one or more appendices attached hereto and/or filed herewith, the disclosures of which are incorporated herein by reference as if fully set out at this point.

Thus, the invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cat toy, comprising:
a main body comprising a toy mounted therein, said main body further comprising one or more openings allowing access said toy mounted within said main body; and
a lid pivotally or rotatably attached within a lid opening of said main body, wherein said toy is attached to said lid.

2. The cat toy of claim 1 further comprising a base member attached to a terminal end of a lower portion of said main body.

3. The cat toy of claim 3 wherein said base member is constructed of a non-slip material to minimize movement of said cat toy during usage.

4. The cat toy of claim 1 wherein an upper portion of said main body is semi-spherical and a lower portion of said main body is circular or annular.

5. The cat toy of claim 1 further comprising a portion of said main body covered or wrapped with a scratch pad-type material.

6. The cat toy of claim 5 wherein said scratch-pad type of material is carpet.

7. The cat toy of claim 1 wherein said openings comprise two (2) coaxial aligned and axial spaced annular openings with said toy accessible through either of said openings.

8. The cat toy of claim 1 wherein said lid is pivotally or rotatably attached to said main body using trunnion support members enabling said lid to pivot or rotate 360 degrees within said lid opening.

9. The cat toy of claim 1 wherein said toy is attached to said lid using a compression spring.

10. The cat toy of claim 1 wherein said toy comprises an animal, a ball, or a feather.

11. The cat toy of claim 1 wherein said toy is configured to squeak, shake and/or make other movements and/or audible noises.

12. The cat toy of claim 11 wherein said movements of said toy cause said lid to pivot or rotate within said lid opening of said main body.

13. The cat toy of claim 1 wherein said cat toy further comprises one or magnets attached to said lid to initiate movement of said lid based on a positive and a negative charged end of said magnets.

14. The cat toy of claim 1 wherein said cat toy further comprises one or more lights and/or lasers attached to said lid and electrically connected to a power source.

15. The cat toy of claim 1 wherein said lid is motion-activated.

16. The cat toy of claim 1 wherein said toy constructed and configured to pop-out of said annular openings within the main body.

17. A cat toy, comprising:
a main body comprising a semi-spherical upper portion and an annular lower portion, said upper portion having coaxial aligned and axial spaced annular openings, said upper portion having a lid opening with a pair of trunnion support members protruding therein;
a lid positioned within said lid opening of said main body, said lid connected to said trunnion support members of said main body;
a cat toy attached to said lid, said toy accessible through either of said openings in said main body; and
a base member attached to a terminal end of said lower portion of said main body, said base member comprising a non-slip material.

18. The cat toy of claim 17 wherein said lid further comprises a motor and a power source, and wherein said toy is moved or rotated by said motor.

19. The cat toy of claim 18 wherein a rotatable mount disk is connected to a drive shaft of said motor, and wherein said toy is secured to the mount disk.

20. The cat toy of claim 18 wherein said lid further comprises a motor housing, wherein said motor is contained within said motor housing and said motor is connected to said mount disk through an opening in said motor housing.
